(19) United States
(12) Patent Application Publication
(10) Pub. No.: US 2024/0192382 A1
(43) Pub. Date: Jun. 13, 2024

(54) APPARATUS AND METHOD FOR DETECTING RECEPTION ENVIRONMENT OF SMALL AND MOBILE GNSS RECEIVER

(71) Applicant: SAMSUNG ELECTRONICS CO., LTD., Suwon-si (KR)

(72) Inventors: Sunkyoung YU, Suwon-si (KR); Youmin JOUNG, Suwon-si (KR); Jungbeom KIM, Suwon-si (KR); Kisoo YU, Suwon-si (KR)

(21) Appl. No.: 18/226,641

(22) Filed: Jul. 26, 2023

(30) Foreign Application Priority Data
Dec. 9, 2022 (KR) 10-2022-0171747
Jan. 19, 2023 (KR) 10-2023-0008354

(51) Int. Cl. G01S 19/26; G01S 19/22

(52) U.S. Cl. CPC G01S 19/26; G01S 19/22

(57) ABSTRACT

A GNSS (global navigation satellite system) receiver includes a signal processing module that receives a satellite signal from a satellite, processes the received satellite signal into a baseband signal, and outputs the baseband signal as input data. A classification module determines a reception environment of the satellite signal through a machine learning model by extracting a plurality of features related to motion characteristics of a user wearing the GNSS receiver (for example, user speed and acceleration) and features of the satellite (for example, number of visible satellites) and outputs environment information. The environment information indicates reception environment. A position calculation module calculates, based on the baseband signal and the environment information, position information of the user corresponding to the position of the GNSS receiver.

### CROSS-REFERENCE TO RELATED APPLICATIONS

This application claims priority under 35 U.S.C. § 119 to Korean Patent Application Nos. 10-2022-0171747, filed on Dec. 9, 2022, and 10-2023-0008354, filed on Jan. 19, 2023, in the Korean Intellectual Property Office, the disclosures of which are incorporated by reference herein in their entireties.

### BACKGROUND

Embodiments of the present disclosure described herein relate to machine learning and mobile devices, and more particularly, relate to an apparatus and method for detecting a reception environment of a small and mobile GNSS receiver.

The performance of navigation using satellite signals of a global navigation satellite system (GNSS) is greatly affected depending on the environment in which the satellite signals are received. For example, when there are obstacles around, multipath errors may occur as GNSS satellite signals are reflected by the obstacles. In addition, in an urban area with many high-rise buildings, the number of visible satellites is small compared to open areas, the geometric distribution of satellites is narrowed, and the effect of multipath error is increased, so the accuracy of the user's position may be lowered. In addition, signal strength may be lowered depending on the environment, and as a result, noise of the receiver may be large. Therefore, it is necessary to develop technologies such as modeling a measurement error or separately developing a navigation filter by determining an environment in which the GNSS satellite signals are received.

Conventional technologies use a high-performance GNSS antenna to determine a signal reception environment with respect to the received satellite signals at a specific posture. The high-performance GNSS antenna uses a Right-Handed Circular Polarization (RHCP) for easy reception of satellite signals and may have a high antenna gain in the zenith direction. In addition, since the antenna gain of the high-performance GNSS antenna is designed to be uniform for all orientations, signals may be equally received for satellites having the same altitude. Due to these characteristics, it is possible to maintain a specific level of signal strength when receiving GNSS satellite signals on the ground, and it is possible to determine the reception environment only with the number of visible satellites and the signal strength. However, in the case of small and mobile GNSS receivers mounted on mobile devices or wearable devices, it is difficult to use high-performance GNSS antennas, and the number of visible satellites and the strength of satellite signals may frequently change because a user's movement occurs frequently. Therefore, there is a limit to determining the reception environment only with the conventional technologies.

### SUMMARY

Embodiments of the present disclosure provide an apparatus and method for determining a reception environment of a small and mobile GNSS receiver in consideration of a user's motion characteristics.

Provided is a GNSS receiver including: a signal processing module configured to receive a satellite signal from a satellite, to process the satellite signal into a baseband signal, and output the baseband signal as input data: a classification module configured to: determine a reception environment of the satellite signal through a machine learning model by extracting, from one or more sensors coupled to the GNSS receiver, a first plurality of features related to motion characteristics of a user wearing the GNSS receiver and extracting, from the input data, a second plurality of features related to the satellite, and output environment information indicating the determined reception environment; and a position calculation module configured to calculate position information indicating a position of the GNSS receiver based on the satellite signal and the environment information.

In some embodiments, the second plurality of features includes a number of visible satellites, a dilution of precision (DOP), a user predicted position error, an average signal strength, a signal strength variation, and/or a duration of signal tracking.

In some embodiments, the classification module includes: a preprocessing module configured to preprocess the first plurality of features and the second plurality of features for input to the machine learning model: a dimension reduction module configured to reduce dimensions of the first plurality of features and the second plurality of features to select a third plurality of features used for classification of the machine learning model; and an environment detection module configured to output the reception environment as the environment information using the third plurality of features and the machine learning model.

In some embodiments, the preprocessing module preprocesses the first plurality of features and the second plurality of features using any one of an average subtraction, a normalization, and a moving average.

In some embodiments, the dimension reduction module is configured to select the third plurality of features used for the classification using a principal component analysis (PCA) with respect to the first plurality of features and the second plurality of features.

In some embodiments, the receiver further includes a learning module configured to: receive learning data, wherein the learning data includes: i) first information corresponding to a second satellite signal measured in a second reception environment originating from a second satellite or the satellite signal received in real time from the satellite and/or ii) second information related to a second user's motion characteristics such as speed and acceleration measured using an acceleration sensor, a geomagnetic sensor, and/or a camera, and train the machine learning model based on the first information and/or the second information.

In some embodiments, the machine learning model is configured to determine the reception environment by using any one of machine learning algorithms of a logistic regression, support vector machines (SVM), a kernel SVM, a decision tree, or a random forest.

In some embodiments, the reception environment is one of an open area or an urban area.

In some embodiments, the position calculation module is configured to: calculate a pseudo range between the satellite and the GNSS receiver by calculating a time difference between time information of the satellite and current time information, and calculate the position information based on the reception environment indicated by the calculated pseudo range and the environment information.

Also provided is a method of determining a reception environment of a GNSS receiver, the method including: receiving a satellite signal from a satellite, processing the satellite signal into a baseband signal, and outputting the baseband satellite signal as input data; extracting, from one or more sensors coupled to the GNSS receiver, a first plurality of features related to motion characteristics of a user wearing the GNSS receiver and extracting, from the input data, a second plurality of features related to the satellite: preprocessing the first plurality of features and the second plurality of features for input to a machine learning model: selecting a third plurality of features used for classification of the machine learning model by reducing dimensions of the first plurality of features and the second plurality of features: outputting environment information indicating the reception environment using the third plurality of features and the machine learning model: and calculating position information indicating a position of the GNSS receiver based on the satellite signal and the environment information.

Also provided is a mobile device including: a processor; a memory configured to store data processed by the processor; and a GNSS receiver controlled by the processor, and wherein the GNSS receiver includes: a signal processing module configured to: receive a satellite signal from a satellite, to process the satellite signal into a baseband signal, and output the baseband satellite signal as input data: a classification module configured to: determine a reception environment of the satellite signal through a machine learning model by extracting, from one or more sensors coupled to the GNSS receiver, a first plurality of features related to motion characteristics of a user wearing the GNSS receiver and extracting, from the input data, a second plurality of features related to the satellite, and output environment information indicating the determined reception environment: and a position calculation module configured to calculate position information indicating a position of the GNSS receiver based on the satellite signal and the environment information.

### BRIEF DESCRIPTION OF THE FIGURES

A detailed description of each drawing is provided to facilitate a more thorough understanding of the drawings referenced in the detailed description of the present disclosure.

FIG. 1 is a block diagram illustrating an example of a GNSS receiver, according to an embodiment of the present disclosure.

FIG. 2 is a block diagram illustrating an example of a learning module of FIG. 1.

FIG. 3 is a block diagram illustrating an example of a classification module of FIG. 1.

FIG. 4 conceptually illustrates a difference according to a user's posture when receiving satellite signals using a GNSS receiver.

FIG. 5 conceptually illustrates a difference in environments in which satellite signals are received using a GNSS receiver.

FIG. 6 illustrates a result of determining a reception environment using a principal component analysis (PCA) and a support vector machine (SVM).

FIG. 7 is a flowchart illustrating an example of a method of training a machine learning model for determining a reception environment of a GNSS receiver, according to an embodiment of the present disclosure.

FIG. 8 is a flowchart illustrating an example of a method for determining a reception environment of a GNSS receiver, according to an embodiment of the present disclosure.

FIG. 9 is a block diagram illustrating an example of a mobile device including a GNSS receiver of FIG. 1.

FIG. 10 is a block diagram illustrating an example of an electronic device in a network environment, according to an embodiment of the present disclosure.

### DETAILED DESCRIPTION

Hereinafter, embodiments of the present disclosure may be described in detail and clearly to such an extent that an ordinary one in the art easily implements the present disclosure.

Components that are described in the detailed description with reference to the terms “unit”, “module”, “block”, “˜er or ˜or”, etc. and function blocks illustrated in drawings will be implemented with software, hardware, or a combination thereof. For example, the software may be a machine code, firmware, an embedded code, and application software. For example, the hardware may include an electrical circuit, an electronic circuit, a processor, a computer, an integrated circuit, integrated circuit cores, a pressure sensor, an inertial sensor, a microelectromechanical system (MEMS), a passive element, or a combination thereof.

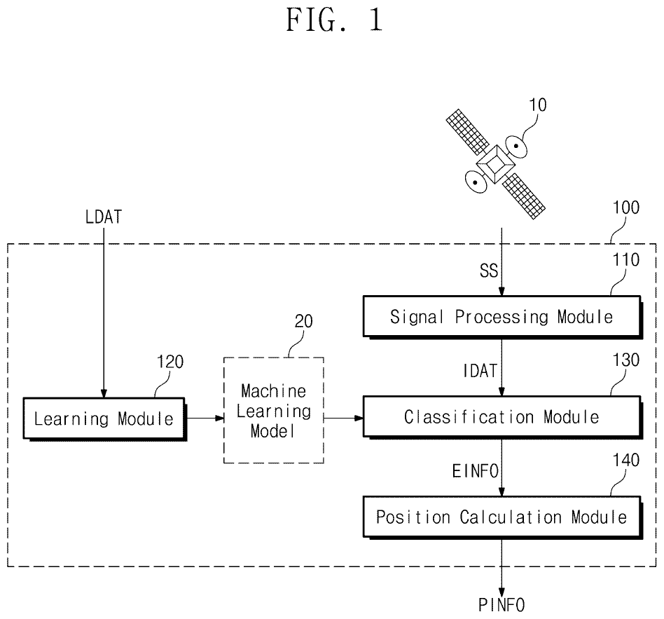

FIG. 1 is a block diagram illustrating an example of a GNSS receiver 100, according to an embodiment of the present disclosure. The GNSS receiver 100 may receive a satellite signal ‘SS’, and may calculate and output position information PINFO of the GNSS receiver 100 based on the received satellite signal SS. In addition, the GNSS receiver 100 may determine the reception environment of the satellite signal SS by using the machine learning model 20 to accurately calculate the position information PINFO. Referring to FIG. 1, the GNSS receiver 100 may include a signal processing module 110, a learning module 120, a classification module 130, and a position calculation module 140. Each of the signal processing module 110, the learning module 120, the classification module 130, and/or the position calculation module 140 may be implemented by separate specialized hardware integrated circuits (“chips”) or by a single chip. Also, each of the signal processing module 110, the learning module 120, the classification module 130, and/or the position calculation module 140 may be implemented by software instructions executed on a hardware processor such as a CPU or GPU.

For example, the GNSS receiver 100 may be implemented on a mobile device such as a mobile phone, a smart phone, a tablet PC, a laptop computer, a personal digital assistant (PDA), a portable multimedia player (PMP), a portable game console, etc., or may be implemented on a wearable electronic device such as a smart watch, a wristband electronic device, a wearable computer, etc. For convenience of description, it is assumed that the GNSS receiver 100 of the present disclosure is a small and mobile receiver implemented on a smart phone or smart watch, but the present disclosure is not limited thereto.

An operation of generating position information PINFO of the GNSS receiver 100 may be affected by an environment (e.g., an urban area, an open area, etc.) in which the satellite signal SS is received. For example, in the urban area and the open area, since the geometric distribution (e.g., the number of visible satellites, etc.) of satellites is different, and the degree of interference is also different while the satellite signals SS reaches the GNSS receiver 100, the GNSS receiver 100 may use different algorithms when calculating the position information PINFO according to the reception environment. Therefore, it is important to determine the reception environment of the GNSS receiver 100 to accurately calculate the position information PINFO. In particular, in the case of the small and mobile GNSS receiver 100, since the antenna performance is inferior to that of a receiver in a fixed environment and an effect of the user's motion characteristics (e.g., user's posture whether the user is walking, running, or riding a bicycle, user's speed, acceleration, etc.) is large, the accuracy of the generated position information PINFO may be relatively low. Therefore, the small and mobile GNSS receiver 100 needs to determine the reception environment with higher accuracy to accurately calculate the position information PINFO.

To this end, the GNSS receiver 100 of the present disclosure may include a machine learning model 20 receiving the satellite signal SS and classifying reception environments. For example, the machine learning model 20 may use a machine learning algorithm of a logistic regression, support vector machines (SVM), a kernel SVM, a decision tree, and/or a random forest to classify the reception environment. For convenience of description, it is hereinafter assumed that the machine learning model 20 uses the SVM algorithm, but the present disclosure is not limited thereto and the machine learning model 20 may classify the reception environment using other algorithms.

The signal processing module 110 may receive the satellite signal SS from a satellite 10 through a GNSS antenna (not illustrated) provided in the GNSS receiver 100, and may process the received satellite signal SS into a baseband signal. Although only one satellite 10 is illustrated in FIG. 1 for convenience of illustration, the actual signal processing module 110 may receive a plurality of satellite signals from a plurality of satellites. For example, the signal processing module 110 may perform filtering, amplification, down conversion, sampling, and digitization on the received satellite signal SS. The signal processing module 110 may provide the processed satellite signal to the classification module 130 as input data IDAT. In addition, in some cases, the signal processing module 110 may provide the processed satellite signal as learning data LDAT to the learning module 120 for real-time learning of the machine learning model 20.

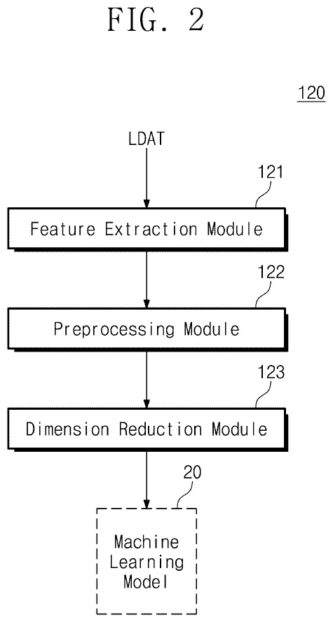

The learning module 120 may train the machine learning model 20 for classifying the reception environments using the learning data LDAT. For example, the learning data LDAT may include satellite signals that are actually measured in various reception environments (e.g., an urban area, an open area, a deep city center, etc.). The learning data LDAT may be provided from an external database (not illustrated) or may be provided in real time from the signal processing module 110 in some cases. The learning module 120 may train the machine learning model 20 to extract features considering user's motion characteristics (e.g., user's posture, user's speed, etc.) and features (a number of visible satellites, a dilution of precision (DOP), a satellite signal strength, etc.) related to the satellite from the satellite signals included in the learning data LDAT, and to classify the reception environments based on the extracted features. Meanwhile, according to embodiments, the learning module 120 may be separately implemented outside the GNSS receiver 100 (e.g., an application processor, etc.). The features related to user motion may referred to as first features or as a first plurality of features. The features related to the satellite may be referred to as second features or as a second plurality of features. The configuration and operation of the learning module 120 will be described in more detail with reference to FIG. 2.

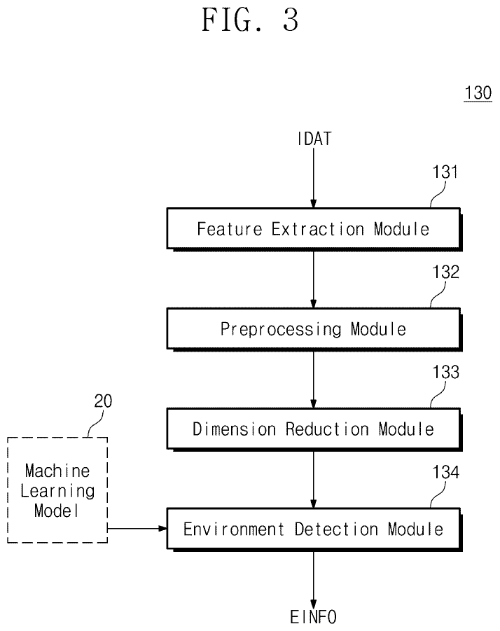

The classification module 130 may receive the input data IDAT processed by the signal processing module 110, may determine the reception environment of the satellite signal SS through the machine learning model 20, and may output the determined the reception environment as environment information EINFO. The classification module 130 may extract features considering the motion characteristics of the user from the input data IDAT received in real time, and may output the environment information EINFO indicating the classification result of the reception environment through the machine learning model 20 based on the extracted features. For example, the environment information EINFO may indicate any one of an urban area, an open area, and a deep city center. The classification module 130 may provide the environment information EINFO to the position calculation module 140. The configuration and operation of the classification module 130 will be described in more detail with reference to FIG. 3.

The position calculation module 140 may calculate and output position information PINFO indicating the position of the GNSS receiver 100 based on the satellite signal SS and the environment information EINFO. In detail, the position calculation module 140 may obtain satellite information (e.g., position of the satellite, time of the satellite, speed of the satellite, etc.) by decoding the satellite signal SS. After that, the position calculation module 140 may calculate a time difference between the time information of the satellite and the current time information to calculate a pseudo range including various errors between the satellite and the GNSS receiver 100, and may calculate the position information PINFO by reflecting the environment information EINFO indicating the reception environment. The position calculation module 140 may calculate the position information PINFO by selecting an appropriate navigation filter or algorithm according to the reception environment indicated by the environment information EINFO.

For convenience of illustration and concise description, it is described that the position calculation module 140 of FIG. 1 performs all of the operations of obtaining satellite information, calculating the pseudo range, and calculating the position information PINFO. However, according to an embodiment, the GNSS receiver 100 may further include separate components for obtaining the satellite information and calculating the pseudo range.

FIG. 2 is a block diagram illustrating an example of the learning module 120 of FIG. 1. As described with reference to FIG. 1, the learning module 120 may extract features from the learning data LDAT and may train the machine learning model 20 to determine the reception environment. The learning data LDAT may include satellite signals received in various environments or signals transmitted in real time through the signal processing module 110. Referring to FIG. 2, the learning module 120 may include a feature extraction module 121, a preprocessing module 122, and a dimension reduction module 123. The feature extraction module 121, the preprocessing module 122, and the dimension reduction module 123 may be implemented as portions of a chip implementing the learning module 120 or as portions of instructions implementing the learning module 120.

The feature extraction module 121 may extract a plurality of features related to motion characteristics of the user and the satellite from satellite signals included in the learning data LDAT to determine a reception environment. For example, the features related to the user's motion characteristics may include speed and acceleration measured using an acceleration sensor, a geomagnetic sensor, a camera, etc., the user's posture (e.g., walking, running, cycling, etc.) received as input from the user or classified through machine learning. These sensors may be coupled to a classification module of the GNSS receiver. In this way, the GNSS receiver can determine a reception environment of the satellite signal through a machine learning model by extracting, from one or more of the sensors, first features related to a motion of the user. In addition, the features related to the satellite (second features) may include the number of visible satellites, the DOP, a user-predicted position error, an average signal strength, an amount of change in signal strength per satellite, a duration of signal tracking per satellite, etc. The feature extraction module 121 may extract the above-described features with respect to the satellite signals collected for each reception environment (e.g., an urban area, an open area, etc.) and provide the extracted features (first and second features) to the preprocessing module 122.

In some embodiments, the learning data LDAT includes: i) first information corresponding to satellite signals received in various environments or signals transmitted in real time and/or ii) second information related to a second user's motion characteristics such as speed and acceleration measured using an acceleration sensor, a geomagnetic sensor, and/or a camera.

The preprocessing module 122 may preprocess the extracted features into a form appropriate for training of the machine learning model 20. For example, the preprocessing module 122 may preprocess the extracted features through methods such as mean subtraction, normalization, and moving average, but the present disclosure is not limited thereto and the preprocessing module 122 may preprocess the extracted features using various other methods. The preprocessing module 122 may provide the preprocessed features to the dimension reduction module 123. In addition, the average and standard deviation of the features calculated by the preprocessing module 122 may be used in a preprocessing module 132 of the classification module 130.

The dimension reduction module 123 may select features that perform an important role in classification of the machine learning model 20 by reducing the dimensions of the preprocessed features (first and second features). For example, the dimension reduction module 123 may use a principal component analysis (PCA), an independent component analysis (ICA), a projection, a manifold learning, and the like to reduce the dimensions of preprocessed features. For example, the dimension reduction module 123 may perform the PCA on the features to set axes capable of preserving data variance. For convenience of description, it is assumed that the dimension reduction module 123 of the present disclosure uses the PCA, but the present disclosure is not limited thereto and the dimension reduction module 123 may reduce the dimension of preprocessed features using other methods. In addition, the PCA result of the dimension reduction module 123 may be used in a dimension reduction module 133 of the classification module 130. The result of the selection may be referred to as third features or a third plurality of features.

The learning module 120 may train reception environment classification (e.g., classification using the SVM) of the machine learning model 20 using the features (e.g., features selected through the PCA) selected by the dimension reduction module 123. For example, the learning module 120 may train the machine learning model 20 using the features selected by the dimension reduction module 123 such that the machine learning model 20 outputs urban area information when the machine learning model 20 receives the satellite signals measured in the urban area and outputs open area information when the machine learning model 20 receives the satellite signals measured in the open area.

FIG. 3 is a block diagram illustrating an example of the classification module 130 of FIG. 1. As described with reference to FIG. 1, the classification module 130 may determine the reception environment of the satellite signal SS through the input data IDAT and the machine learning model 20 and output the determined reception environment as environment information EINFO. Referring to FIG. 3, the classification module 130 may include a feature extraction module 131, the preprocessing module 132, the dimension reduction module 133, and an environment detection module 134. The feature extraction module 131, the preprocessing module 132, the dimension reduction module 133, and the environment detection module 134 may be implemented as portions of a chip implementing the classification module 130 or as portions of the instructions implementing the classification module 130.

As described in the feature extraction module 121 of FIG. 2, the feature extraction module 131 may extract a plurality of features related to motion characteristics of the user and the satellite from the satellite signals included in the input data IDAT. As described in the preprocessing module 122 of FIG. 2, the preprocessing module 132 may preprocess the extracted features through methods such as average subtraction, normalization, and moving average. For example, the preprocessing module 132 may normalize the features of the input data IDAT based on the mean and standard deviation of the features calculated in the preprocessing module 122 of FIG. 2.

As described in the dimension reduction module 123 of FIG. 2, the dimension reduction module 133 may select features that perform an important role in classification of the machine learning model 20 by reducing the dimension of the preprocessed features. For example, the dimension reduction module 133 may perform the PCA based on the PCA result of the dimension reduction module 123 of FIG. 2 and normalized feature values. The environment detection module 134 may determine the reception environment (e.g., the urban area or the open area) of the satellite signal SS received in real time through the machine learning model 20 based on the PCA result, and may output the determined reception environment as environment information EINFO. The output environment information EINFO may be used to generate the position information PINFO in the position calculation module 140 of FIG. 1.

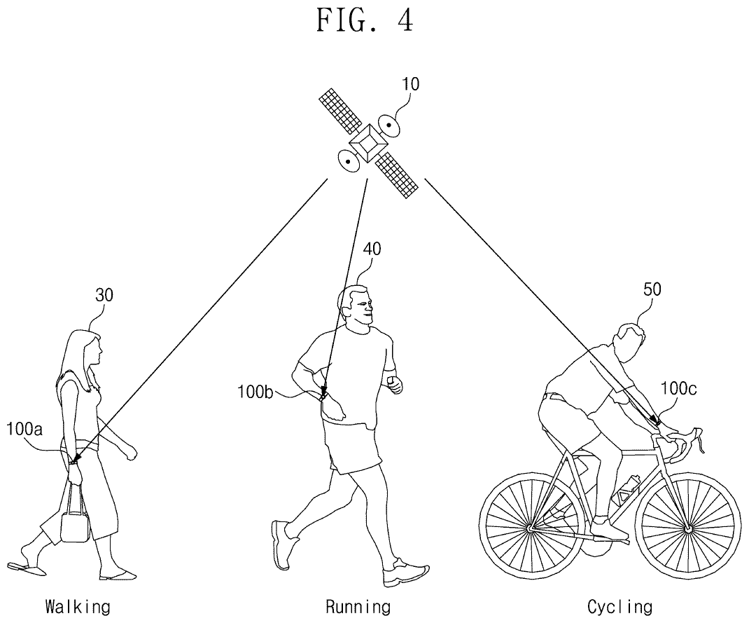

FIG. 4 conceptually illustrates a difference according to a user's posture when receiving satellite signals using a GNSS receiver. Referring to FIG. 4, a user 30 is walking, a user 40 is running, a user 50 is riding a bicycle, and the users 30, 40, and 50 are wearing GNSS receivers 100a, 100b, and 100c, respectively. Assuming that the users 30, 40, and 50 are positioned in the same place and the GNSS receivers 100a, 100b, and 100c receive satellite signals from the satellite 10, the features (e.g., speed and acceleration of the users) related to motions of the users 30, 40, and 50 extracted from the satellite signals received by each of the GNSS receivers 100a, 100b, and 100c may appear different from one another. For example, the walking user 30 may have the slowest speed and the bicycle riding user 50 may have the fastest speed.

As described above, since the GNSS receivers 100a, 100b, and 100c are small and mobile types, and are greatly affected by changes in user's motion characteristics, the accuracy of position information may be low. Therefore, the GNSS receivers 100a, 100b, and 100c of the present disclosure may determine the reception environment of the satellite signals in consideration of the user's motion characteristics (including the user's posture and the user's speed and acceleration), and may calculate the position information by selecting an appropriate navigation filter or algorithm based on the reception environment and motion characteristics of the user. For convenience of illustration, only one satellite 10 is illustrated in FIG. 4, but it will be understood that the GNSS receivers 100a, 100b, and 100c actually receive a plurality of satellite signals from a plurality of satellites.

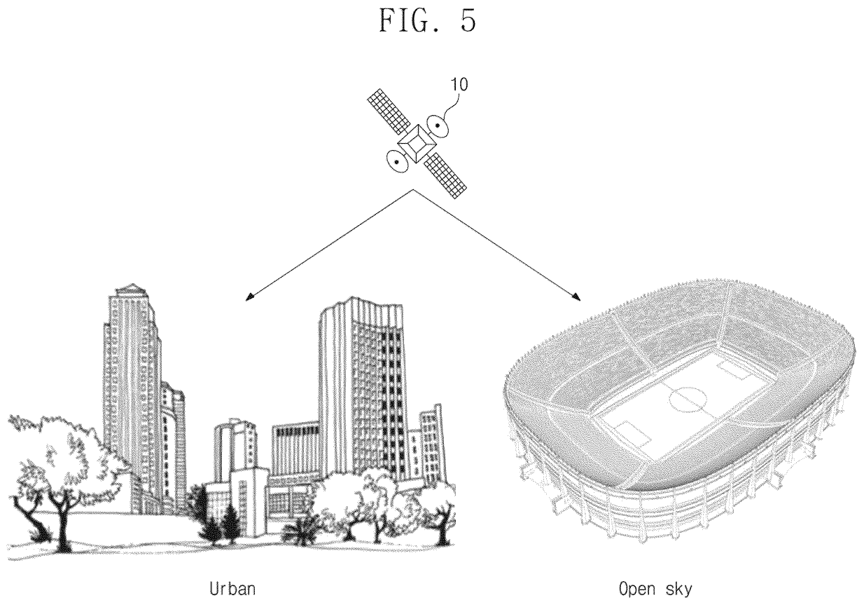

FIG. 5 conceptually illustrates a difference in environments in which satellite signals are received using a GNSS receiver. Referring to FIG. 5, an urban area and an open area are illustrated as examples of environments in which satellite signals are received from the satellite 10. For example, since high-rise buildings are more distributed in the urban area than in the open area, the number of visible satellites may be smaller, the geometric distribution of satellites may be narrower, and the influence of position errors may be greater than in the open area. In detail, in urban areas and open areas, satellite information (e.g., satellite position, time, speed, etc.) and features (e.g., the number of visible satellites, the DOP, the user-predicted position error, the average signal strength, the amount of change in signal strength per satellite, the duration of signal tracking per satellite, etc.) related to the satellite may appear differently. Considering these differences and the differences according to motion characteristics described with reference to FIG. 4 together, the GNSS receiver (100 in FIG. 1) may determine the reception environment of the satellite signal and may calculate the position information with a high-accuracy. Although only one satellite 10 is illustrated in FIG. 5 for convenience of illustration, it will be understood that a GNSS receiver located in an urban area or an open area actually receives a plurality of satellite signals from a plurality of satellites.

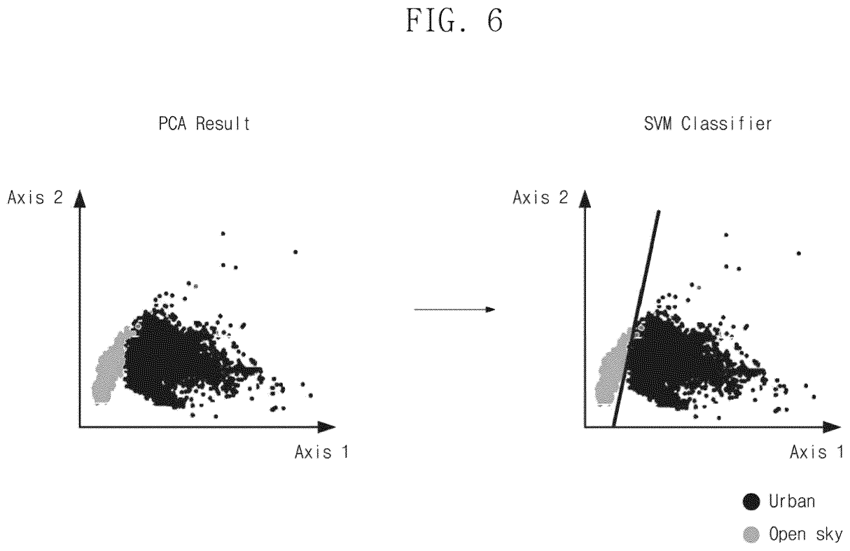

FIG. 6 illustrates a result of determining a reception environment using a principal component analysis (PCA) and a support vector machine (SVM). In detail, FIG. 6 illustrates a result of determining a reception environment using the machine learning model (20 of FIG. 1) after receiving a satellite signal, when a user wears a mobile device including the GNSS receiver (100 in FIG. 1) and performs exercises such as stopping, walking, and running in an open area and in an urban area, respectively. A left graph illustrates a result of reducing the features extracted from satellite signals through the PCA to two features (expressed in two dimensions, first axis and second axis) that are of high importance in determining the reception environment, and a right graph illustrates an SVM classifier trained based on the extracted features and the PCA results. In the two graphs, a gray color represents the satellite signal measured in the open area, and a black color represents the satellite signal measured in the urban area. In the right graph, a solid line represents a classification baseline of the trained SVM classifier. The classification module 130 of FIG. 1 may determine the reception environment of the received satellite signal using the SVM classifier trained in this way.

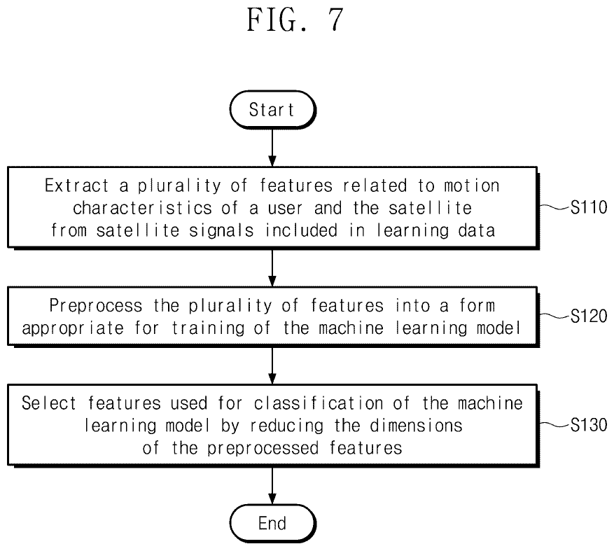

FIG. 7 is a flowchart illustrating an example of a method of training a machine learning model for determining a reception environment of a GNSS receiver, according to an embodiment of the present disclosure. Hereinafter, it will be described with reference to FIGS. 1 and 2 together with FIG. 7.

In operation S110, the feature extraction module 121 of the learning module 120 may extract a plurality of features related to the motion characteristics of a user and the satellite from satellite signals included in the learning data LDAT. In operation S120, the preprocessing module 122 of the learning module 120 may preprocess the extracted features into a form appropriate for training of the machine learning model 20. For example, the preprocessing module 122 may preprocess the extracted features using any one of average subtraction, normalization, and moving average. In operation S130, the dimension reduction module 123 of the learning module 120 may reduce the dimensions of the preprocessed features to select features used for classification of the machine learning model 20. For example, dimension reduction module 123 may perform the PCA on the preprocessed features. Through the above operations, the learning module 120 may train the reception environment classification (e.g., classification using the SVM) of the machine learning model 20 using the features (e.g., features selected through the PCA) selected by the dimension reduction module 123.

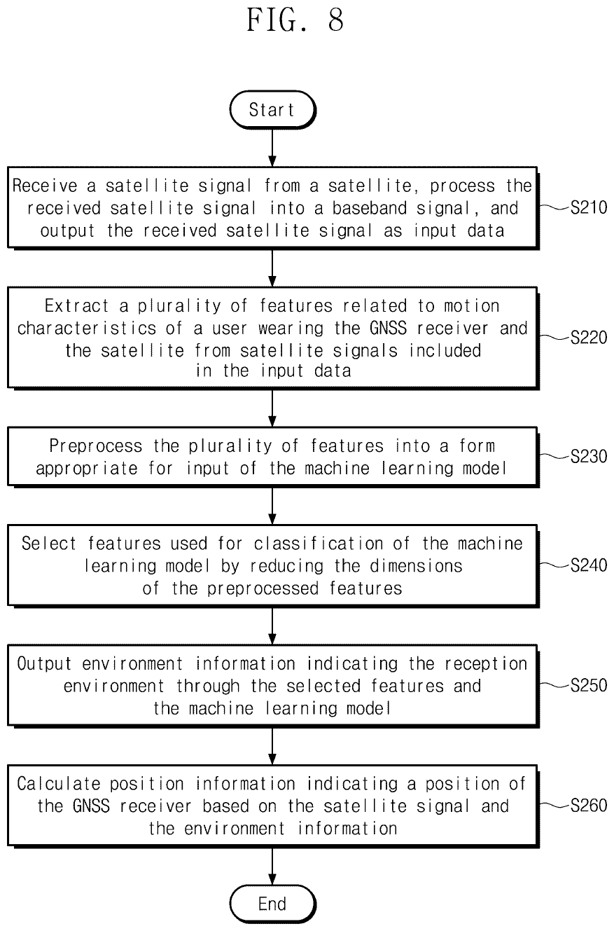

FIG. 8 is a flowchart illustrating an example of a method for determining a reception environment of a GNSS receiver, according to an embodiment of the present disclosure. Hereinafter, it will be described with reference to FIGS. 1 and 3 together with FIG. 8.

In operation S210, the signal processing module 110 may receive the satellite signal SS from the satellite 10, may process the received satellite signal SS into a baseband signal, and may output the received satellite signal SS as the input data IDAT. In operation S220, the feature extraction module 131 of the classification module 130 may extract a plurality of features related to motion characteristics of the user (a first plurality of features) and the satellite (a second plurality of features) from the satellite signals included in the input data IDAT. In operation S230, the preprocessing module 132 of the classification module 130 may preprocess the extracted features into a form appropriate for the input of the machine learning model 20. For example, the preprocessing module 132 may preprocess the extracted features (the first plurality of features and the second plurality of features) using any one of average subtraction, normalization, and moving average.

In operation S240, the dimension reduction module 133 of the classification module 130 may reduce the dimensions of the preprocessed features to select features used for classification of the machine learning model 20. The selected features may be referred to as a third plurality of features. For example, the dimension reduction module 133 may perform the PCA on the preprocessed features. In operation S250, the environment detection module 134 of the classification module 130 may output environment information EINFO indicating the reception environment through the features selected through dimension reduction and the machine learning model 20. In operation S260, the position calculation module 140 may calculate the position information PINFO indicating the position of the GNSS receiver 100 based on the satellite signal SS and environment information EINFO.

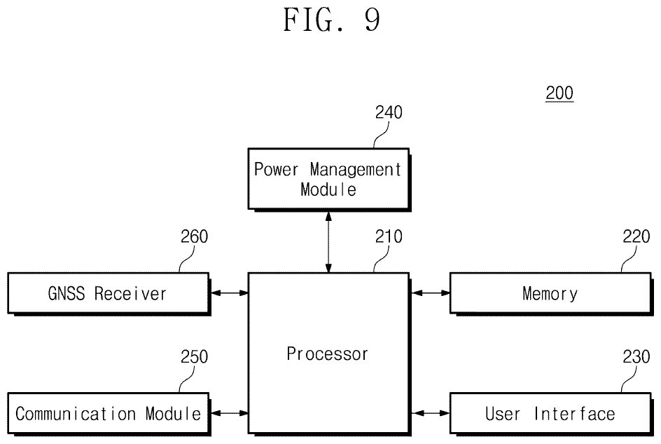

FIG. 9 is a block diagram illustrating an example of a mobile device 200 including the GNSS receiver 100 of FIG. 1. Referring to FIG. 9, the mobile device 200 may include a processor 210, a memory 220, a user interface 230, a power management module 240, a communication module 250, and a GNSS receiver 260.

The processor 210 may execute various computing functions such as specific calculations or tasks. For example, the processor 210 may be any processor such as a central processing unit (CPU), a graphics processing unit (GPU), a neural processing unit (NPU), a microprocessor, an application processor (AP), etc. The processor 210 may execute an operating system (OS) for driving the mobile device 200 and may execute various applications providing an internet browser, a game, a video, a camera, etc. According to an embodiment, the processor 210 may include one processor core or a plurality of processor cores. In addition, according to embodiments, the processor 210 may further include an internal or external cache memory.

The memory 220 may store data processed by the processor 210 or may operate as a working memory. The memory 220 may store a boot image for booting the mobile device 200, a file system related to an operating system for driving the mobile device 200, a device driver related to an external device connected to the mobile device 200, applications executed in the mobile device 200, etc. For example, the memory 220 may include at least one volatile memory such as a DRAM, an SRAM, a mobile DRAM, a DDR SDRAM, an LPDDR SDRAM, a GDDR SDRAM, an RDRAM, etc., or may include at least one non-volatile memory such as an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), a ferroelectric random access memory (FRAM)), etc.

The user interface 230 may include one or more input devices, such as keypads, buttons, microphones, touch screens, and/or one or more output devices, such as speakers and display devices. The power management module 240 may supply an operating voltage of the mobile device 200.

The communication module 250 may communicate with an external device. For example, the communication module 250 may perform USB communication, Ethernet communication, near field communication (NFC), radio frequency identification (RFID) communication, mobile communication, memory card communication, etc. For example, the communication module 250 may include a baseband chipset and may support communication such as GSM, GPRS, WCDMA, HSxPA, etc.

The GNSS receiver 260 may be controlled by the processor 210. The GNSS receiver 260 may be the GNSS receiver 100 of FIG. 1 and may operate based on the methods described above with reference to FIGS. 1 to 3. For example, the GNSS receiver 260 may include a signal processing module, a learning module, a classification module, a position calculation module, and a machine learning model for determining a reception environment. The GNSS receiver 260 may determine the reception environment of the GNSS receiver 260 through machine learning, and accordingly, may accurately calculate the position information of the GNSS receiver 260. Accordingly, position information of the user of the mobile device 200 including the GNSS receiver 260 may also be accurately calculated.

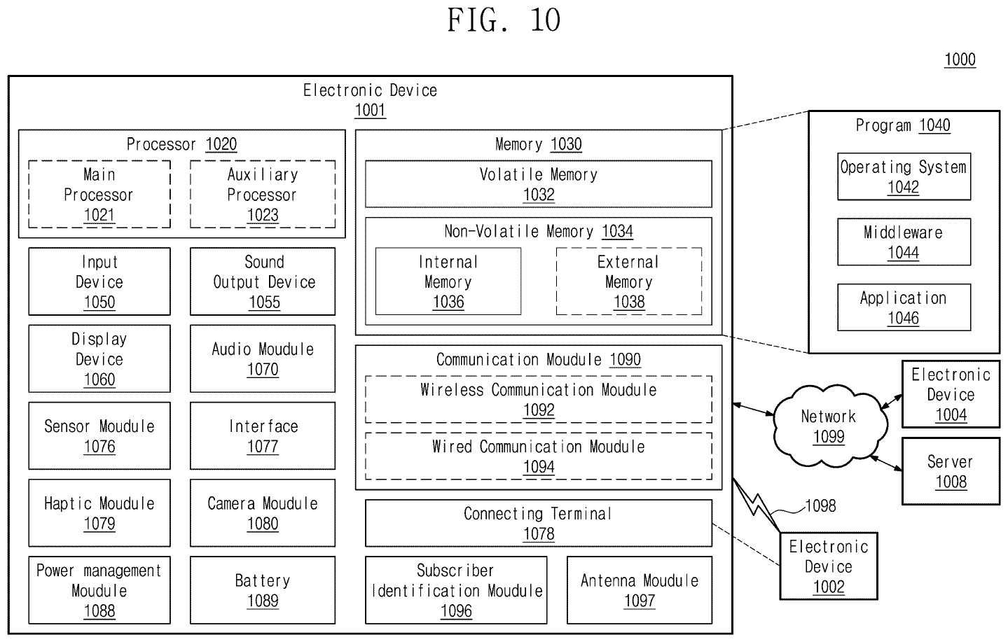

FIG. 10 is a block diagram illustrating an example of an electronic device 1001 in a network environment 1000. For example, the electronic device 1001 of FIG. 10 may be the mobile device 200 of FIG. 9. Referring to FIG. 10, the electronic device 1001 in the network environment 1000 may communicate with an electronic device 1002 through a first network 1098 (e.g., a long-distance wireless communication network) or may communicate with an electronic device 1004 or a server 1008 through a second network 1099 (e.g., a short-range wireless communication network). The electronic device 1001 may communicate with the electronic device 1004 through the server 1008. The electronic device 1001 includes a processor 1020, a memory 1030, an input device 1050, an sound output device 1055, a display device 1060, an audio module 1070, a sensor module 1076, an interface 1077, a haptic module 1079, a camera module 1080, a power management module 1088, a battery 1089, a communication module 1090, a subscriber identity module (SIM) 1096, and/or an antenna module 1097.

According to an embodiment, at least one of the components (e.g., the display device 1060 or the camera module 1080) is omitted from the electronic device 1001, or one or more other components are added to the electronic device 1001. According to an embodiment, some of the components may be implemented with a single integrated circuit (IC). For example, the sensor module 1076 (e.g., a fingerprint sensor, an iris sensor, or an illumination sensor) may be embedded in the display device 1060 (e.g., a display).

For example, the processor 1020 may execute software (e.g., a program 1040) to control at least one other component (e.g., hardware component or software component) of the electronic device 1001 connected to the processor 1020, and may perform various data processing or calculations. As at least part of data processing or computation, the processor 1020 may load instructions or data received from other components (e.g., the sensor module 1076 or the communication module 1090) in a volatile memory 1032, may process commands or data stored in the volatile memory 1032, and may store the resulting data in a non-volatile memory 1034. The processor 1020 may include a main processor 1021 (e.g., a central processing unit (CPU) or an application processor (AP)) and an auxiliary processor 1023 (e.g., a graphics processing unit (GPU), an image signal processor (ISP), a sensor hub processor, or a communication processor (CP)) which may operate independently of or in conjunction with the main processor 1021. Additionally or alternatively, the auxiliary processor 1023 may be configured to consume less power than main processor 1021 or to perform specific functions. The auxiliary processor 1023 may be implemented separately from the main processor 1021 or may be implemented as a part thereof.

The auxiliary processor 1023 may control at least some of the functions or states associated with at least one (e.g., the display device 1060, the sensor module 1076, or the communication module 1090) of the components of the electronic device 1001, instead of the main processor 1021 while the main processor 1021 is in an inactive (e.g., sleep) state, or together with the main processor 1021 while the main processor 1021 is in an active (e.g., running an application) state. According to an embodiment, the auxiliary processor 1023 (e.g., ISP or CP) may be implemented as part of other components (e.g., the camera module 1080 or the communication module 1090) functionally related to the auxiliary processor 1023.

The memory 1030 may store various data used by at least one component (e.g., the processor 1020 or the sensor module 1076) of the electronic device 1001. For example, the various data may include input data or output data with respect to software (e.g., the program 1040) and commands related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input device 1050 may receive commands or data to be used by other components (e.g., the processor 1020) of the electronic device 1001 from the outside (e.g., a user) of the electronic device 1001. The input device 1050 may include, for example, a microphone, a mouse device, or a keyboard.

The sound output device 1055 may output a sound signal to the outside of the electronic device 1001. For example, the sound output device 1055 may include a speaker or a receiver. The speaker may be used for general purposes such as multimedia playback or recording, and the receiver may be used to receive an incoming call. According to an embodiment, the receiver may be implemented separately from the speaker or as a part of the speaker.

The display device 1060 may visually provide information to the outside (e.g., a user) of the electronic device 1001. For example, the display device 1060 may include a display, a hologram device, or a projector, and a control circuit to control a corresponding one of the display, the hologram device, and the projector. For example, the display device 1060 may include a touch circuit configured to detect a touch or a sensor circuit (e.g., a pressure sensor) configured to measure the strength of a force generated by a touch.

The audio module 1070 may convert sound into an electrical signal or vice versa. For example, the audio module 1070 may acquire sound through the input device 1050 or may output sound directly (e.g., wiredly) or wirelessly to the electronic device 1001 through the sound output device 1055 or headphones of the external electronic device 1002.

The sensor module 1076 detects an operating state (e.g., power or temperature) of the electronic device 1001 or an external environmental state (e.g., a user's state) of the electronic device 1001, and then generates an electrical signal or data value corresponding to the detected states. The sensor module 1076 may be, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used to connect the electronic device 1001 to the external electronic device 1002 directly (e.g., wiredly) or wirelessly. For example, the interface 1077 may include a high-definition multimedia interface (HDMI), a universal serial bus (USB) interface, a secure digital (SD) card interface, or an audio interface.

A connection terminal 1078 may include a connector through which the electronic device 1001 is physically connected to the external electronic device 1002. For example, the connection terminal 1078 may include an HDMI connector, a USB connector, an SD card connector, or an audio connector (e.g., a headphone connector).

The haptic module 1079 may convert electrical signals into mechanical stimuli (e.g., vibration or motion) or electrical stimuli that can be recognized by a user through tactile or kinesthetic sensations. For example, the haptic module 1079 may include a motor, a piezoelectric element, or an electrical stimulator.

The camera module 1080 may capture still images or moving images. For example, the camera module 1080 may include one or more lenses, image sensors, ISPs, or flashes.

The power management module 1088 may manage power supplied to the electronic device 1001. For example, the power management module 1088 may be implemented as at least part of a power management integrated circuit (PMIC). The battery 1089 may supply power to at least one component of the electronic device 1001. For example, the battery 1089 may include a non-rechargeable primary battery, a rechargeable secondary battery, or a fuel cell.

The communication module 1090 may support a direct (e.g., wired) communication channel setting or a wireless communication channel setting between the electronic device 1001 and an external electronic device (e.g., the electronic device 1002, the electronic device 1004, or the server 1008), and may support performing communication through the established communication channel. The communication module 1090 may include one or more CPs that may operate independently of the processor 1020 (e.g., an AP), and support direct (e.g., wired) communication or wireless communication. For example, the communication module 1090 may include a wireless communication module 1092 (e.g., a cellular communication module, a short-range wireless communication module, or a GNSS communication module) or a wired communication module 1094 (e.g., a local area network (LAN) communication module or power line communication (PLC) module).

Corresponding one of these communication modules may communicate with an external electronic device through the first network 1098 (e.g., a short-range communication network such as Bluetooth® Wi-Fi Direct or the Infrared Data Association (IrDA) standard) or the second network 1099 (e.g., a long-distance communication network such as a cellular network, Internet, or a computer network (e.g., LAN or wide area network (WAN)). These various types of communication modules may be implemented with a single component (e.g., a single IC) or may be implemented with several components (e.g., multiple ICs) separated from each other. The wireless communication module 1092 may identify and authenticate electronic device 1001 on the communication networks such as the first network 1098 or the second network 1099 using subscriber information (e.g., International Mobile Subscriber Identity (IMSI)) stored in a subscriber identification module 1096. For example, the communication module 1090 of the electronic device 1001 may include the GNSS receiver 100 of FIG. 1 and may determine the reception environment of the GNSS receiver 100 through machine learning.

The antenna module 1097 may transmit and receive signals or power to and from the outside (e.g., an external electronic device) of the electronic device 1001. The antenna module 1097 may include one or more antennas, and among them, at least one antenna suitable for a communication method used in a communication network such as the first network 1098 or the second network 1099 may be selected by the communication module 1090 (e.g., the wireless communication module 1092). Accordingly, the signals or power may be transmitted and received between the communication module 1090 and an external electronic device through the selected at least one antenna.

At least some of the components described above are coupled to each other through a peripheral-to-peripheral communication method (e.g., a bus, a universal input and output (GPIO), a serial peripheral interface (SPI), or a mobile industry processor interface (MIPI)) to communicate signals (e.g., commands or data) therebetween.

For example, commands or data may be transmitted and received between the electronic device 1001 and the external electronic device 1004 through the server 1008 coupled with the second network 1099. Each of the electronic devices 1002 and 1004 may be a device of the same type as the electronic device 1001 or a different type of device. All or part of operations to be executed in the electronic device 1001 may be executed in one or more of the external electronic devices 1002, 1004, and 1008. For example, when the electronic device 1001 needs to perform a function or service automatically or at the request of a user or other device, the electronic device 1001 instead of or in addition to executing the function or service, may request one or more external electronic devices to perform at least part of a function or service. The one or more external electronic devices that receive the request may perform at least a part of the requested function or service, or an additional function or additional service related to the request, and transfer the execution result to the electronic device 1001. The electronic device 1001 may provide the result, as at least part of the response to the request, with or without further processing of the result. For example, cloud computing, distributed computing or client-server computing technologies may be used for this purpose.

A method for determining a reception environment of a GNSS receiver according to an embodiment of the present disclosure may be implemented in software (e.g., the program 1040) including one or more commands stored a storage medium (e.g., an internal memory 1036 or an external memory 1038) readable by a machine (e.g., the electronic device 1001). For example, the processor of the electronic device 1001 may invoke at least one of one or more instructions stored in a storage medium and may execute the instructions under the control of the processor with or without using one or more other components. Thus, the machine may be operated to perform at least one function according to the at least one invoked command. One or more instructions may include codes generated by a compiler or codes executable by an interpreter. A machine-readable storage medium may be provided in the form of a non-transitory storage medium. The term “non-transitory” indicates that the storage medium is a tangible device and does not contain signals (e.g., electromagnetic waves), but the term does not distinguish between where the data is stored semi-permanently in the storage media and where the data is temporarily stored in the storage media.

According to an embodiment of the present disclosure, when a user wearing a small and mobile GNSS receiver performs various motions, a reception environment of a satellite signal may be determined in consideration of an effect of motion characteristics.

In addition, according to an embodiment of the present disclosure, a signal tracking filter optimized for each reception environment of a satellite signal may be designed, and the accuracy of position information calculation may be improved by optimizing a navigation algorithm for each reception environment.

The above description refers to embodiments for implementing the present disclosure. Embodiments in which a design is changed simply or which are easily changed may be included in the present disclosure as well as an embodiment described above. In addition, technologies that are easily changed and implemented by using the above embodiments may be included in the present disclosure. Accordingly, the scope of the present disclosure should not be limited to the above-described embodiments and should be defined by equivalents of the claims as well as the claims to be described later.

What is claimed is:

1. A GNSS (global navigation satellite system) receiver comprising:
a signal processing module configured to receive a satellite signal from a satellite, to process the satellite signal into a baseband signal, and output the baseband signal as input data;
a classification module configured to:
determine a reception environment of the satellite signal through a machine learning model by extracting, from one or more sensors coupled to the GNSS receiver, a first plurality of features related to motion characteristics of a user wearing the GNSS receiver and extracting, from the input data, a second plurality of features related to the satellite, and
output environment information indicating the determined reception environment; and
a position calculation module configured to calculate position information indicating a position of the GNSS receiver based on the satellite signal and the environment information.

2. The GNSS receiver of claim 1, wherein the first plurality of features comprises a speed, an acceleration, and/or a posture of the user, and
wherein the second plurality of features comprises a number of visible satellites, a dilution of precision (DOP), a user predicted position error, an average signal strength, a signal strength variation, and/or a duration of signal tracking.

3. The GNSS receiver of claim 1, wherein the classification module comprises:
a preprocessing module configured to preprocess the first plurality of features and the second plurality of features for input to the machine learning model;
a dimension reduction module configured to reduce dimensions of the first plurality of features and the second plurality of features to select a third plurality of features used for classification of the machine learning model; and
an environment detection module configured to output the reception environment as the environment information using the third plurality of features and the machine learning model.

4. The GNSS receiver of claim 3, wherein the preprocessing module preprocesses the first plurality of features and the second plurality of features using any one of an average subtraction, a normalization, and a moving average.

5. The GNSS receiver of claim 3, wherein the dimension reduction module is configured to select the third plurality of features used for the classification using a principal component analysis (PCA) with respect to the first plurality of features and the second plurality of features.

6. The GNSS receiver of claim 1, further comprising a learning module configured to:
receive learning data, wherein the learning data comprises: i) first information corresponding to a second satellite signal measured in a second reception environment originating from a second satellite or the satellite signal received in real time from the satellite and/or ii) second information related to a second user's motion characteristics such as speed and acceleration measured using an acceleration sensor, a geomagnetic sensor, and/or a camera, and
train the machine learning model based on the first information and/or the second information.

7. The GNSS receiver of claim 1, wherein the machine learning model is configured to determine the reception environment by using any one of machine learning algorithms of a logistic regression, support vector machines (SVM), a kernel SVM, a decision tree, or a random forest.

8. The GNSS receiver of claim 1, wherein the reception environment is one of an open area or an urban area.

9. The GNSS receiver of claim 1, wherein the position calculation module is configured to:
calculate a pseudo range between the satellite and the GNSS receiver by calculating a time difference between time information of the satellite and current time information, and
calculate the position information based on the reception environment indicated by the calculated pseudo range and the environment information.

10. A method of determining a reception environment of a GNSS (global navigation satellite system) receiver, the method comprising:
receiving a satellite signal from a satellite, processing the satellite signal into a baseband signal, and outputting the baseband satellite signal as input data;
extracting, from one or more sensors coupled to the GNSS receiver, a first plurality of features related to motion characteristics of a user wearing the GNSS receiver and extracting, from the input data, a second plurality of features related to the satellite;
preprocessing the first plurality of features and the second plurality of features for input to a machine learning model;
selecting a third plurality of features used for classification of the machine learning model by reducing dimensions of the first plurality of features and the second plurality of features;
outputting environment information indicating the reception environment using the third plurality of features and the machine learning model; and
calculating position information indicating a position of the GNSS receiver based on the satellite signal and the environment information.

11. The method of claim 10, wherein the first plurality of features related to the motion characteristics of the user comprises a speed, an acceleration, and a posture of the user, and
wherein the second plurality of features related to the satellite comprises a number of visible satellites, a dilution of precision (DOP), a user predicted position error, an average signal strength, a signal strength variation, and a duration of signal tracking.

12. The method of claim 10, wherein the preprocessing of the first plurality of features and the second plurality of features comprises preprocessing the first plurality of features and the second plurality of features using any one of an average subtraction, a normalization, and a moving average.

13. The method of claim 10, wherein the selecting the third plurality of features comprises selecting using a principal component analysis (PCA) with respect to the first plurality of features and the second plurality of features.

14. The method of claim 10, wherein the machine learning model is configured to determine the reception environment by using any one of machine learning algorithms of a logistic regression, support vector machines (SVM), a kernel SVM, a decision tree, or a random forest.

15. A mobile device comprising:
a processor;
a memory configured to store data processed by the processor; and
a GNSS (global navigation satellite system) receiver controlled by the processor, and
wherein the GNSS receiver comprises:
a signal processing module configured to:
receive a satellite signal from a satellite, to process the satellite signal into a baseband signal, and
output the baseband satellite signal as input data;
a classification module configured to:
determine a reception environment of the satellite signal through a machine learning model by extracting, from one or more sensors coupled to the GNSS receiver, a first plurality of features related to motion characteristics of a user wearing the GNSS receiver and extracting, from the input data, a second plurality of features related to the satellite, and
output environment information indicating the determined reception environment; and
a position calculation module configured to calculate position information indicating a position of the GNSS receiver based on the satellite signal and the environment information.

16. The mobile device of claim 15, wherein the classification module comprises:
a preprocessing module configured to preprocess the first plurality of features and the second plurality of features for input to the machine learning model;
a dimension reduction module configured to reduce dimensions of the first plurality of features and the second plurality of features to select a third plurality of features used for classification of the machine learning model; and
an environment detection module configured to output the reception environment as the environment information using the third plurality of features and the machine learning model.

17. The mobile device of claim 16, wherein the preprocessing module is configured to preprocess the first plurality of features and the second plurality of features using any one of an average subtraction, a normalization, or a moving average.

18. The mobile device of claim 16, wherein the dimension reduction module is configured to select the third plurality of features used for the classification using a principal component analysis (PCA) with respect to the first plurality of features and the second plurality of features.

19. The mobile device of claim 15, wherein the GNSS receiver further comprises a learning module configured to:
receive learning data, wherein the learning data comprises: i) first information corresponding to a second satellite signal measured in a second reception environment originating from a second satellite or the satellite signal received in real time from the satellite and/or ii) second information related to a second user's motion characteristics such as speed and acceleration measured using an acceleration sensor, a geomagnetic sensor, and/or a camera, and
train the machine learning model based on the first information and/or the second information.

20. The mobile device of claim 15, wherein the machine learning model is configured to determine a mobile device environment by using any one of machine learning algorithms of a logistic regression, support vector machines (SVM), a kernel SVM, a decision tree, or a random forest.
